(19) United States
(12) Patent Application Publication
(10) Pub. No.: US 2021/0160481 A1
(43) Pub. Date: May 27, 2021

(54) FLEXIBLE SIGNALING OF QP OFFSET FOR ADAPTIVE COLOR TRANSFORM IN VIDEO CODING

(71) Applicant: QUALCOMM Incorporated, San Diego, CA (US)

(72) Inventors: Han Huang, San Diego, CA (US); Chun-Chi Chen, San Diego, CA (US); Adarsh Krishnan Ramasubramonian, Irvine, CA (US); Vadim Seregin, San Diego, CA (US); Wei-Jung Chien, San Diego, CA (US); Geert Van der Auwera, Del Mar, CA (US); Marta Karczewicz, San Diego, CA (US)

(21) Appl. No.: 17/103,415

(22) Filed: Nov. 24, 2020

Related U.S. Application Data
(60) Provisional application No. 62/940,728, filed on Nov. 26, 2019.
(60) Provisional application No. 62/954,318, filed on Dec. 27, 2019.

(51) Int. Cl. H04N 19/105; H04N 19/61; H04N 19/186; H04N 19/176

(52) U.S. Cl. CPC H04N 19/105; H04N 19/176; H04N 19/186; H04N 19/61

(57) ABSTRACT

A video decoder can be configured to determine that a block of the video data is encoded using an adaptive color transform (ACT); determine that the block is encoded in a joint chroma mode, wherein for the joint chroma mode a single chroma residual block is encoded for a first chroma component of the block and a second chroma component of the block; determine a quantization parameter (QP) for the block; determine an ACT quantization parameter (QP) offset for the block based on the block being encoded using the ACT and encoded in the joint chroma mode; and determine an ACT QP for the block based on the QP and the ACT QP offset.

This application claims the benefit of

U.S. Provisional Patent Application 62/940,728, filed 26 Nov. 2019, and

U.S. Provisional Patent Application 62/954,318, filed 27 Dec. 2019, the entire content of both being hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

This disclosure describes techniques for coding blocks of video data using both an adaptive color transform (ACT) and a joint chroma mode that may offer improved coding efficiency over existing techniques for using ACT in combination with joint chroma mode. As will be explained in more detail below, when using ACT, the video encoder and video decoder apply an offset to the quantization parameter (QP) value to determine an ACT QP value. The video encoder and video decoder then use the ACT QP value for quantizing and dequantizing the transform coefficients. This disclosure describes techniques for determining an ACT QP offset that may improve overall video coding efficiency for coding scenarios that use ACT in conjunction with joint chroma mode. More specifically, by determining an ACT QP offset for the block based on the block being encoded using the ACT and encoded in the joint chroma mode and determining an ACT QP for the block based on the QP and the ACT QP offset, the techniques of this disclosure may improve the overall coding quality of video data in coding scenarios that use both ACT and a joint chroma mode.

According to one example, a method of decoding video data, the method comprising: determining that a block of the video data is encoded using an adaptive color transform (ACT); determining that the block is encoded in a joint chroma mode, wherein for the joint chroma mode a single chroma residual block is encoded for a first chroma component of the block and a second chroma component of the block; determining a quantization parameter (QP) for the block; determining an ACT quantization parameter (QP) offset for the block based on the block being encoded using the ACT and encoded in the joint chroma mode; determining an ACT QP for the block based on the QP and the ACT QP offset; determining the single chroma residual block based on the ACT QP for the block; determining a first chroma residual block for the first chroma component from the single chroma residual block, wherein the first chroma residual block is in a first color space; determining a second chroma residual block for the second chroma component from the single chroma residual block, wherein the second chroma residual block is in the first color space; performing an inverse ACT on the first chroma residual block to convert the first chroma residual block to a second color space; and performing the inverse ACT on the second chroma residual block to convert the second chroma residual block to the second color space.

According to one example, a device for decoding video data includes a memory configured to store video data and one or more processors implemented in circuitry and configured to determine that a block of the video data is encoded using an adaptive color transform (ACT); determine that the block is encoded in a joint chroma mode, wherein for the joint chroma mode a single chroma residual block is encoded for a first chroma component of the block and a second chroma component of the block; determine a quantization parameter (QP) for the block; determine an ACT quantization parameter (QP) offset for the block based on the block being encoded using the ACT and encoded in the joint chroma mode; determine an ACT QP for the block based on the QP and the ACT QP offset; determine the single chroma residual block based on the ACT QP for the block; determine a first chroma residual block for the first chroma component from the single chroma residual block, wherein the first chroma residual block is in a first color space; determine a second chroma residual block for the second chroma component from the single chroma residual block, wherein the second chroma residual block is in the first color space; perform an inverse ACT on the first chroma residual block to convert the first chroma residual block to a second color space; and perform the inverse ACT on the second chroma residual block to convert the second chroma residual block to the second color space.

According to another example, an apparatus for decoding video data includes means for determining that a block of the video data is encoded using an adaptive color transform (ACT); means for determining that the block is encoded in a joint chroma mode, wherein for the joint chroma mode a single chroma residual block is encoded for a first chroma component of the block and a second chroma component of the block; means for determining a quantization parameter (QP) for the block; means for determining an ACT quantization parameter (QP) offset for the block based on the block being encoded using the ACT and encoded in the joint chroma mode; means for determining an ACT QP for the block based on the QP and the ACT QP offset; means for determining the single chroma residual block based on the ACT QP for the block; means for determining a first chroma residual block for the first chroma component from the single chroma residual block, wherein the first chroma residual block is in a first color space; means for determining a second chroma residual block for the second chroma component from the single chroma residual block, wherein the second chroma residual block is in the first color space; means for performing an inverse ACT on the first chroma residual block to convert the first chroma residual block to a second color space; and means for performing the inverse ACT on the second chroma residual block to convert the second chroma residual block to the second color space.

According to another example, a computer-readable storage medium stores instructions that when executed by one or more processors cause the one or more processors to determine that a block of the video data is encoded using an adaptive color transform (ACT); determine that the block is encoded in a joint chroma mode, wherein for the joint chroma mode a single chroma residual block is encoded for a first chroma component of the block and a second chroma component of the block; determine a quantization parameter (QP) for the block; determine an ACT quantization parameter (QP) offset for the block based on the block being encoded using the ACT and encoded in the joint chroma mode; determine an ACT QP for the block based on the QP and the ACT QP offset; determine the single chroma residual block based on the ACT QP for the block; determine a first chroma residual block for the first chroma component from the single chroma residual block, wherein the first chroma residual block is in a first color space; determine a second chroma residual block for the second chroma component from the single chroma residual block, wherein the second chroma residual block is in the first color space; perform an inverse ACT on the first chroma residual block to convert the first chroma residual block to a second color space; and perform the inverse ACT on the second chroma residual block to convert the second chroma residual block to the second color space.

According to another example, a method of encoding video data includes determining a first chroma residual block for a first chroma component of a block of video data; determining a second chroma residual block for a second chroma component of the block of video data, wherein the first chroma residual block and the second chroma residual block are in a first color space; determining that the block of the video data is encoded using an adaptive color transform (ACT); performing the ACT on the first chroma residual block to convert the first chroma residual block to a second color space; performing the inverse ACT on the second chroma residual block to convert the second chroma residual block to the second color space; determining that the block of the video data is encoded in a joint chroma mode, wherein for the joint chroma mode a single chroma residual block is encoded for the first chroma component of the block and the second chroma component of the block; determining the single chroma residual block based on the converted first chroma residual block and the converted second chroma residual block; determining a quantization parameter (QP) for the block; determining an ACT quantization parameter (QP) offset for the block based on the block being encoded using the ACT and encoded in the joint chroma mode; determining an ACT QP for the block based on the QP and the ACT QP offset; and quantizing the single chroma residual block based on the ACT QP for the block.

According to another example, a device for encoding video data includes a memory configured to store video data and one or more processors implemented in circuitry and configured to determine a first chroma residual block for a first chroma component of a block of video data; determine a second chroma residual block for a second chroma component of the block of video data, wherein the first chroma residual block and the second chroma residual block are in a first color space; determine that the block of the video data is encoded using an adaptive color transform (ACT); perform the ACT on the first chroma residual block to convert the first chroma residual block to a second color space; perform the inverse ACT on the second chroma residual block to convert the second chroma residual block to the second color space; determine that the block of the video data is encoded in a joint chroma mode, wherein for the joint chroma mode a single chroma residual block is encoded for the first chroma component of the block and the second chroma component of the block; determine the single chroma residual block based on the converted first chroma residual block and the converted second chroma residual block; determine a quantization parameter (QP) for the block; determine an ACT quantization parameter (QP) offset for the block based on the block being encoded using the ACT and encoded in the joint chroma mode; determine an ACT QP for the block based on the QP and the ACT QP offset; and quantize the single chroma residual block based on the ACT QP for the block.

According to another example, an apparatus for encoding video data includes means for determining a first chroma residual block for a first chroma component of a block of video data; means for determining a second chroma residual block for a second chroma component of the block of video data, wherein the first chroma residual block and the second chroma residual block are in a first color space; means for determining that the block of the video data is encoded using an adaptive color transform (ACT); means for performing the ACT on the first chroma residual block to convert the first chroma residual block to a second color space; means for performing the inverse ACT on the second chroma residual block to convert the second chroma residual block to the second color space; means for determining that the block of the video data is encoded in a joint chroma mode, wherein for the joint chroma mode a single chroma residual block is encoded for the first chroma component of the block and the second chroma component of the block; means for determining the single chroma residual block based on the converted first chroma residual block and the converted second chroma residual block; means for determining a quantization parameter (QP) for the block; means for determining an ACT quantization parameter (QP) offset for the block based on the block being encoded using the ACT and encoded in the joint chroma mode; means for determining an ACT QP for the block based on the QP and the ACT QP offset; and means for quantizing the single chroma residual block based on the ACT QP for the block.

According to another example, a computer-readable storage medium stores instructions that when executed by one or more processors cause the one or more processor to determine a first chroma residual block for a first chroma component of a block of video data; determine a second chroma residual block for a second chroma component of the block of video data, wherein the first chroma residual block and the second chroma residual block are in a first color space; determine that the block of the video data is encoded using an adaptive color transform (ACT); perform the ACT on the first chroma residual block to convert the first chroma residual block to a second color space; perform the inverse ACT on the second chroma residual block to convert the second chroma residual block to the second color space; determine that the block of the video data is encoded in a joint chroma mode, wherein for the joint chroma mode a single chroma residual block is encoded for the first chroma component of the block and the second chroma component of the block; determine the single chroma residual block based on the converted first chroma residual block and the converted second chroma residual block; determine a quantization parameter (QP) for the block; determine an ACT quantization parameter (QP) offset for the block based on the block being encoded using the ACT and encoded in the joint chroma mode; determine an ACT QP for the block based on the QP and the ACT QP offset; and quantize the single chroma residual block based on the ACT QP for the block.

The details of one or more examples of the disclosure are set forth in the accompanying drawings and the description below. Other features, objects, and advantages of the disclosure will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIG. 3 is a block diagram illustrating an example video encoder that may perform the techniques of this disclosure.

FIG. 4 is a block diagram illustrating an example video decoder that may perform the techniques of this disclosure.

FIG. 5 is a flowchart illustrating a process for encoding video data.

FIG. 6 is a flowchart illustrating a process for decoding video data.

FIG. 7 is a flowchart illustrating a process for decoding video data.

FIG. 8 is a flowchart illustrating a process for encoding video data.

### DETAILED DESCRIPTION

Video coding (e.g., video encoding and/or video decoding) typically involves predicting a block of video data from either an already coded block of video data in the same picture (e.g., intra prediction) or an already coded block of video data in a different picture (e.g., inter prediction). In some instances, the video encoder also calculates residual data by comparing the prediction block to the original block. Thus, the residual data represents a difference between the prediction block and the original block. To reduce the number of bits needed to signal the residual data, the video encoder transforms and quantizes the residual data and signals the transformed and quantized residual data in the encoded bitstream. The compression achieved by the transform and quantization processes may be lossy, meaning that transform and quantization processes may introduce distortion into the decoded video data. The amount of quantization is controlled by a quantization parameter (QP). In some instances, prior to transform and quantization, the video encoder may also apply an adaptive color transform (ACT) to the residual data to transform the residual data from a first color space to a second color space. An ACT may, for example, be used in coding scenarios where the residual data can be more efficiently coded in the second color space than the first color space.

A video decoder performs an inverse quantization, inverse transform, and inverse ACT to decode the residual data, and then adds the decoded residual data to the prediction block to produce a reconstructed video block that matches the original video block more closely than the prediction block alone. Due to the loss introduced by the transforming and quantizing of the residual data, the first reconstructed block may have distortion or artifacts. One common type of artifact or distortion is referred to as blockiness, where the boundaries of the blocks used to code the video data are visible.

To further improve the quality of decoded video, a video decoder can perform one or more filtering operations on the reconstructed video blocks. Examples of these filtering operations include deblocking filtering, sample adaptive offset (SAO) filtering, and adaptive loop filtering (ALF). Parameters for these filtering operations may either be determined by a video encoder and explicitly signaled in the encoded video bitstream or may be implicitly determined by a video decoder without needing the parameters to be explicitly signaled in the encoded video bitstream.

As will be explained in more detail below, video data is frequently coded in blocks of luma samples with two corresponding blocks of chroma samples. The video data may be coded in a joint chroma mode, also referred to as a JointCbCr mode, where a video encoder encodes a single chroma residual block for the two corresponding blocks of chroma residual samples, and the video decoder then derives the two corresponding blocks of chroma residual samples from the single chroma residual block.

This disclosure describes techniques for coding blocks of video data using both ACT and a joint chroma mode (e.g., JointCbCr mode) that may offer improved coding efficiency over existing techniques for using ACT in combination with joint chroma mode. As will be explained in more detail below, when using ACT, the video encoder and video decoder apply an offset to the QP value to determine an ACT QP value. The video encoder and video decoder then use the ACT QP value for quantizing and dequantizing the transform coefficients. This disclosure describes techniques for determining an improved ACT QP offset that may improve overall video coding efficiency for coding scenarios that use ACT in conjunction with joint chroma mode. More specifically, by determining an ACT QP offset for the block based on the block being encoded using the ACT and encoded in the joint chroma mode and determining an ACT QP for the block based on the QP and the ACT QP offset, the techniques of this disclosure may improve the overall coding quality of video data in coding scenarios that use both ACT and a joint chroma mode.

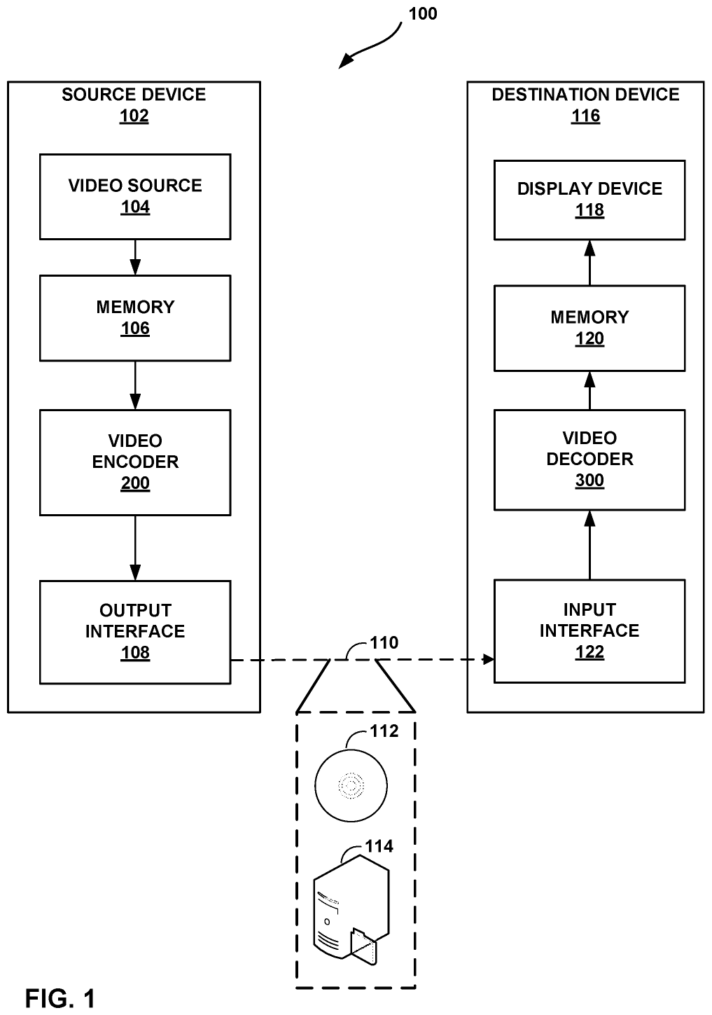

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for flexible signaling of QP offsets for ACT. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for flexible signaling of QP offsets for ACT. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A draft of the VVC standard is described in Bross, et al. “Versatile Video Coding (Draft 7),” Joint Video Experts Team (JVET) of ITU-T SG 16 WP 3 and ISO/IEC JTC 1/SC 29/WG 11, 16^{th} Meeting: Geneva, CH, 1-11 Oct. 2019, JVET-P2001-v14 (hereinafter “VVC Draft 7”). Another draft of the VVC standard is described in Bross, et al. “Versatile Video Coding (Draft 10),” Joint Video Experts Team (JVET) of ITU-T SG 16 WP 3 and ISO/IEC JTC 1/SC 29/WG 11, 18^{th} Meeting: by teleconference, 22 Jun.-1 Jul. 2020, JVET-52001-v17 (hereinafter “VVC Draft 10”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

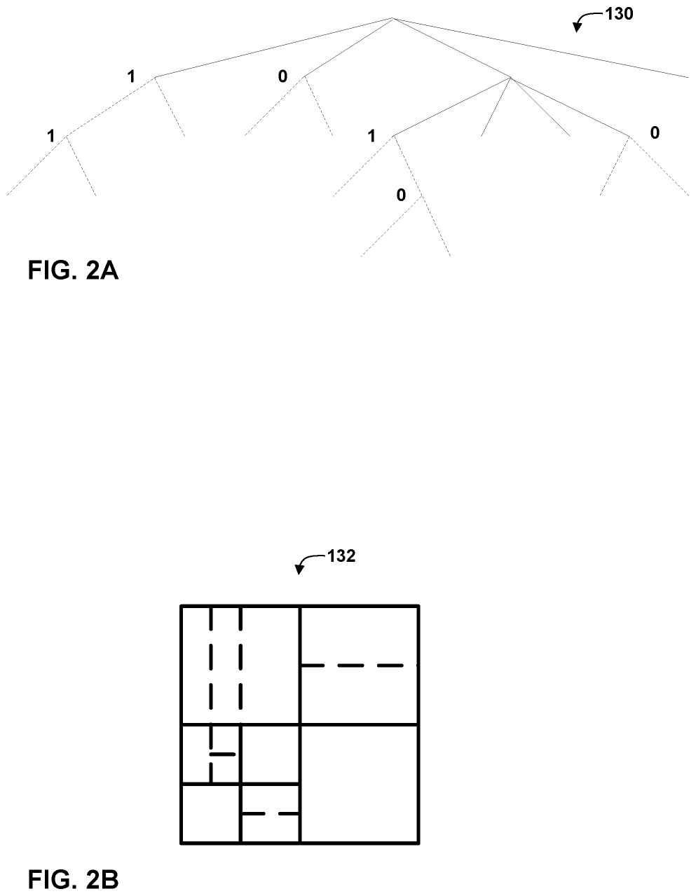

FIGS. 2A and 2B are conceptual diagrams illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, because quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130. A CTU may be partitioned with either single tree partitioning or dual tree partitioning. With single tree partitioning, the chroma component of the CTU and the luma component of the CTU have the same partitioning structure. With dual tree partitioning, the chroma component of the CTU and the luma component of the CTU potentially have different partitioning structure.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), then the nodes can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the quadtree leaf node is 128×128, the leaf quadtree node will not be further split by the binary tree, because the size exceeds the MaxBTSize (i.e., 64×64, in this example). Otherwise, the quadtree leaf node will be further partitioned by the binary tree. Therefore, the quadtree leaf node is also the root node for the binary tree and has the binary tree depth as 0. When the binary tree depth reaches MaxBTDepth (4, in this example), no further splitting is permitted. A binary tree node having a width equal to MinBTSize (4, in this example) implies that no further vertical splitting (that is, dividing of the width) is permitted for that binary tree node. Similarly, a binary tree node having a height equal to MinBTSize implies no further horizontal splitting (that is, dividing of the height) is permitted for that binary tree node. As noted above, leaf nodes of the binary tree are referred to as CUs, and are further processed according to prediction and transform without further partitioning.

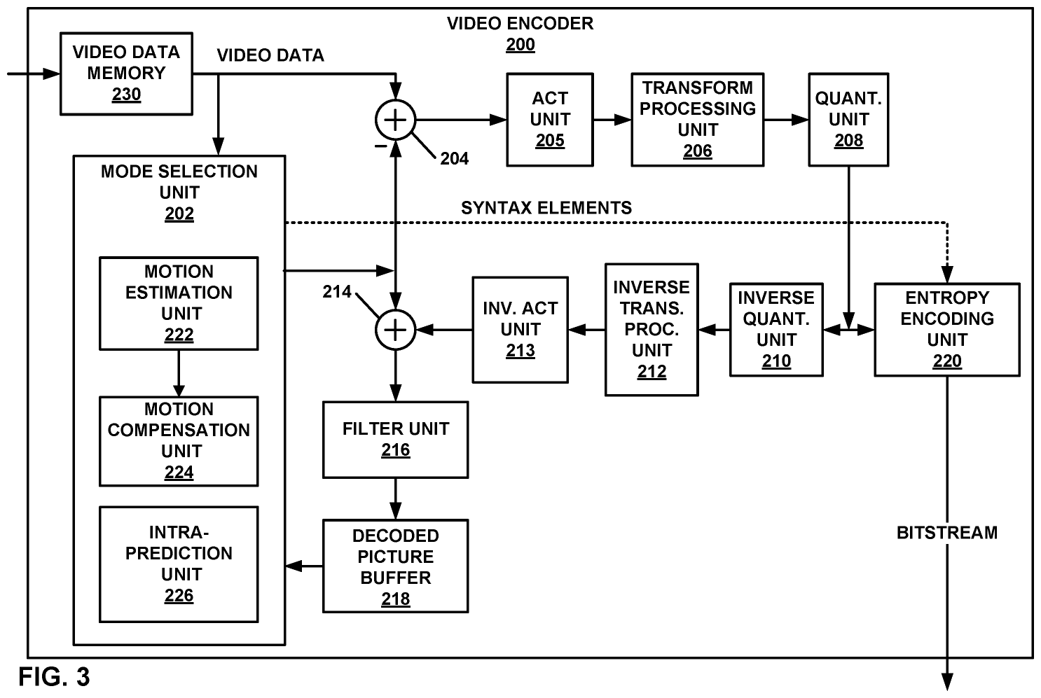

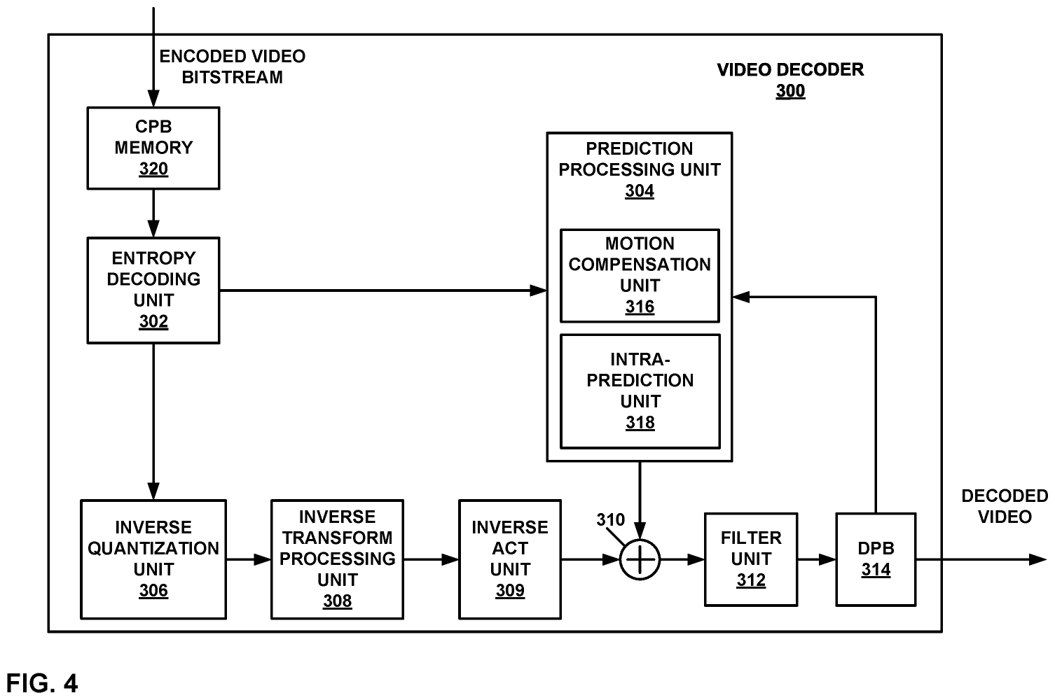

In the HEVC screen content coding (SCC) extension, ACT was adopted to adaptively convert prediction residuals from one color space to a second color space, such as a YCgCo space. Two color spaces can be adaptively selected by signaling one ACT flag. For example, the flag equal to one may indicate that the residuals are coded in the YCgCo space. Otherwise, the flag equal to 0 may indicate that the residuals are coded in the original color space. A similar technique was adopted in VVC, where the color space conversion is carried out in the residual domain. Specifically, one additional decoding unit, namely an inverse ACT unit, described in more detail with respect to FIGS. 3 and 4, is introduced after inverse transform to convert the residuals from the YCgCo domain back to the original domain.

The forward and inverse YCgCo color transform matrices are as follows:

$$[ \begin{matrix}{C}_{0}^{′} \\ {C}_{1}^{′} \\ {C}_{2}^{′}\end{matrix} ] = [ \begin{matrix}2 & 1 & 1 \\ 2 & - 1 & - 1 \\ 0 & - 2 & 2\end{matrix} ] [ \begin{matrix}{C}_{0} \\ {C}_{1} \\ {C}_{2}\end{matrix} ] / 4 \qquad [ \begin{matrix}{C}_{0} \\ {C}_{1} \\ {C}_{2}\end{matrix} ] = [ \begin{matrix}1 & 1 & 0 \\ 1 & - 1 & - 1 \\ 1 & - 1 & 1\end{matrix} ] [ \begin{matrix}{C}_{0}^{′} \\ {C}_{1}^{′} \\ {C}_{2}^{′}\end{matrix} ]$$

Additionally, to compensate for the dynamic range change of residual signals before and after color transform, QP adjustments of (−5, −5, −3) are applied to the transform residuals. That is, the QP for a quantization group may be adjusted for blocks that are coded with ACT. ACT is implemented in a manner such that ACT applied at video encoder 200 can be reversed by video decoder 300. To compensate for the dynamic range change of residuals signals before and after color transform, QP adjustments may be applied to the transform residuals by adding QP offsets to different color components. That is, the QP used in the first color space is modified before quantization or inverse quantization is performed in the second color space. The QP offsets may be signaled as high-level syntax.

In HEVC, the syntax element residual_adaptive_colour_transform_enabled_flag is signaled as part of a PPS to indicate whether ACT is enabled. The syntax elements of QP offsets for ACT_pps_act_y_qp_offset_plus5, pps_act_cb_qp_offset_plus5 and pps_act_cr_qp_offset_plus3 are signaled as part of the PPS if residual_adaptive_colour_transform_enabled_flag is true. A pps_slice_act_qp_offsets_present_flag is also signaled when residual_adaptive_colour_transform_enabled_flag is true to indicate whether slice level QP offsets for ACT are present in a slice header. If pps_slice_act_qp_offsets_present_flag is true, the syntax elements slice_act_y_qp_offset, slice_act_cb_qp_offset, and slice_act_cr_qp_offset are signaled in a slice header. The semantics of QP offset for ACT at PPS and slice header are as follows:
pps_act_y_qp_offset_plus5, pps_act_cb_qp_offset_plus5 and pps_act_cr_qp_offset_plus3 are used to determine the offsets that are applied to the quantization parameter values qP derived in clause 8.6.2 for the luma, Cb and Cr components, respectively, when tu_residual_act_flag[xTbY][yTbY] is equal to 1. When not present, the values of pps_act_y_qp_offset_plus5, pps_act_cb_qp_offset_plus5 and pps_act_cr_qp_offset_plus3 are inferred to be equal to 0.

The variable PpsActQpOffsetY is set equal to pps_act_y_qp_offset_plus5-5. The variable PpsActQpOffsetCb is set equal to pps_act_cb_qp_offset_plus5-5. The variable PpsActQpOffsetCr is set equal to pps_act_cb_qp_offset_plus3-3. slice_act_y_qp_offset, slice_act_cb_qp_offset and slice_act_cr_qp_offset specify offsets to the quantization parameter values qP derived in clause 8.6.2 for luma, Cb, and Cr components, respectively. The values of slice_act_y_qp_offset, slice_act_cb_qp_offset and slice_act_cr_qp_offset shall be in the range of −12 to +12, inclusive. When not present, the values of slice_act_y_qp_offset, slice_act_cb_qp_offset, and slice_act_cr_qp_offset are inferred to be equal to 0. The value of PpsActQpOffsetY+slice_act_y_qp_offset shall be in the range of −12 to +12, inclusive. The value of PpsActQpOffsetCb+slice_act_cb_qp_offset shall be in the range of −12 to +12, inclusive. The value of PpsActQpOffsetCr+slice_act_cr_qp_offset shall be in the range of −12 to +12, inclusive.
If ACT is applied for a block, the QP for the luma block is derived by adding PpsActQpOffsetY+slice_act_y_qp_offset, the QP for the Cb block is derived by adding PpsActQpOffsetCb+slice_act_cb_qp_offset, the QP for the Cr block is derived by adding PpsActQpOffsetCr+slice_act_cr_qp_offset.

According to the techniques of this disclosure, video encoder 200 and video decoder 300 may be configured to perform flexible signaling of QP offsets.

According to one technique, the QP offset signaling for ACT may be present in a slice header. A flag pps_slice_act_qp_offsets_present_flag may be used to control whether the QP offsets for ACT are present at slice header. The pps_slice_act_qp_offsets_present_flag may be signaled at picture parameter set when ACT is enabled. However, the QP offset signaling for ACT at slice header is disabled (skipped) if the current slice uses more than one block partitioning tree structure.

In the case of VVC, wherein a qtbt_dual_tree_intra_flag is signaled to indicate whether the I slice in the sequence uses dual-tree block partitioning structure, the QP offset signaling for ACT at slice header is as follows:

if(pps_slice_act_qp_offsets_present_flag && !(

slice_{—}type = = I && qtbtt_{—}dual_{—}tree_{—}intra_{—}flag)){

| | |
|---|---|
| slice_ act _y_qp_offset | se(v) |
| slice_ act _cb_qp_offset | se(v) |
| slice_ act _cr_qp_offset | se(v) |

| | |
|---|---|
| } | se(v) |

The syntax elements of QP offset for ACT, slice_act_y_qp_offset, slice_act_cb_qp_offset and slice_act_cr_qp_offset are only signaled if all of the following are true:
1) pps_slice_act_qp_offsets_present_flag is true, meaning for example, that ACT QP offsets are indicated at the PPS level to be signalled at the slice level.
2) slice_type is not I or qtbt_dual_tree_intra_flag is false, meaning for example, that the slice is not an intra predicted slice or that dual tree partitioning is not enabled.

According to some techniques of this disclosure, video encoder 200 and video decoder 300 may signal the QP offset of each color component for ACT jointly for Y and Cb at slice header as follows:
joint QP offset for Y and Cb components:

if(pps_slice_act_qp_offsets_present_flag && !(

slice_{—}type = = I && qtbtt_{—}dual_{—}tree_{—}intra_{—}flag)){

| | |
|---|---|
| slice_ act _y_cb_qp_offset | se(v) |
| slice_ act _cr_qp_offset | se(v) |

| | |
|---|---|
| } | se(v) |

joint QP offset for Y and Cr components:

if(pps_slice_act_qp_offsets_present_flag && !(

slice_{—}type = = I && qtbtt_{—}dual_{—}tree_{—}intra_{—}flag)){

| | |
|---|---|
| slice_ act _y_cr_qp_offset | se(v) |
| slice_ act _cb_qp_offset | se(v) |

| | |
|---|---|
| } | se(v) |

joint QP offset for Cb and Cr components:

if(pps_slice_act_qp_offsets_present_flag && !(

slice_{—}type = = I && qtbtt_{—}dual_{—}tree_{—}intra_{—}flag)){

| | |
|---|---|
| slice_ act _y_qp_offset | se(v) |
| slice_ act _cb_cr_qp_offset | se(v) |

| | |
|---|---|
| } | se(v) |

joint QP offset for all color components:

if(pps_slice_act_qp_offsets_present_flag && !(

slice_{—}type = = I && qtbtt_{—}dual_{—}tree_{—}intra_{—}flag)){

| | |
|---|---|
| slice_ act _qp_offset | se(v) |

| | |
|---|---|
| } | se(v) |

According to some techniques of this disclosure, the QP offset signaling for ACT in a slice header may not be modified relative to VVC Draft 7 but may be constrained such that the QP offsets are zero if the current slice uses more than one block partitioning tree structure, e.g., if the current slice uses both single and dual tree partitioning.

According to some techniques of this disclosure, none of the QP offsets for ACT are signaled in the case of lossless coding (e.g. for the coding scenarios where transform-bypass flag is one in HEVC or where QP=4 in VVC). Specifically, ACT is not used for each CU when the CU is lossless coded. The CU-level flag and Quantization Group of Coding Unit (QGCU)-level flag introduced below may not be present in bitstream when the CU is lossless coded.

According to techniques of this disclosure, video encoder 200 and video decoder 300 may be configured to encode and decode an enabling flag for ACT at a QGCU level.

According to some techniques of this disclosure, whether ACT is enabled or disabled can be signaled with a QGCU, meaning that ACT may be applied on a QGCU basis. Once ACT is applied, transformed residual coefficients (when transform performs), residual samples (when transform skip performs), and palette pixels (such as palette color and escape pixels when palette mode is used) within a QGCU may all be coded in the color-transformed domain. Besides, the CU-level flag for enabling ACT may not be needed. According to some techniques of this disclosure, there is no CU-level flag to switch ACT on/off because ACT is a QGCU-level coding tool, whereas according to other techniques of this disclosure, this CU-level flag is still present to maintain the flexibility to switch ACT on/off at a finer granularity, such as CU or TU level.

According to techniques of this disclosure, video encoder 200 and video decoder 300 may be configured to perform QP clipping for ACT.

To ensure the QP value used for transformed residual samples, transform-skipped residual and palette is never out-of-range, some techniques of this disclosure may include clipping the resulting QP value after the QP value is adjusted by ACT. Without loss of generality, the notations, Δy, Δcb and Δcr represent for the QP adjustment value (i.e., slice-header QP offset+picture-level QP offset when ACT is enabled for the current residual samples; otherwise, 0) for the three color components, respectively.
QP′y=Clip3(0, QPmax+QpBdOffset, QPy+QpBdOffset+Δy),
QP′cb=Clip3(0, QPmax+QpBdOffset, QPcr+QpBdOffset+Δcb),
QP′cr=Clip3(0, QPmax+QpBdOffset, QPcr+QpBdOffset+Δcr),
   where QPmax is the maximal QP value supported in a video coding standard, e.g. 51 for HEVC and 63 for VVC, QpBdOffset=6*(internal bit depth—8) and the function Clip3(a,b,c) clips the value of c within the range from a to b, inclusive.
   It is noted that, according to some techniques of this disclosure, the respective values of Δy, Δcb and Δcr are pre-determined for some video codecs that do not support flexible QP signaled for ACT. In such cases, these QP offset values are configured as follows:
Δy=−5,
Δcb=−5,
Δcr=−3.

According to some techniques of this disclosure, QP clipping can be combined with the QGCU-level signaling as described above with respect to an enabling flag for ACT at QGCU level The delta QP (i.e., the delta between original QP and the minimal allowed QP) range can be adjusted based on the value of Δy. As the minimal value of base QP is 0, the minimal value of QPy can be derived as follows:

QPy_min+6*(internal bit depth−8)+Δy=0,

and thus:

QPy_min=−6*(internal bit depth−8)−Δy.

Thus, the delta QP between the original QP (i.e., QPy) and the minimum allowed QP (i.e., QPy_min) can be derived.

ΔQP=QPy_min−Qpy=−6*(internal bit depth−8)−Δy−QPy.

According to techniques of this disclosure, video encoder 200 and video decoder 300 may be configured to perform QP clipping for ACT when transform coding is skipped.

According to some techniques of this disclosure, the minimal QP value can not reach as low as 0 to prevent signal expansion when transform coding is not used. The QP values (i.e., QP′y, QP′cb, QP′cr) derived above may be further adjusted as follows:
QP′y=Max(QP′y, M+6*(internal bit depth−input bit depth)),
QP′cb=Max(QP′cb, M+6*(internal bit depth−input bit depth)),
QP′cr=Max(QP′cr, M+6*(internal bit depth−input bit depth)),
   or, to be more precisely in a self-contained form,
QP′y=Clip3(M+6*(internal bit depth−input bit depth), QPmax+QpBdOffset, QPy+QpBdOffset+Δy),
QP′cb=Clip3(M+6*(internal bit depth−input bit depth), QPmax+QpBdOffset, QPcr+QpBdOffset+Δcb),
QP′cr=Clip3(M+6*(internal bit depth−input bit depth), QPmax+QpBdOffset, QPcr+QpBdOffset+Δcr),
   where M is the QP value (e.g. 4 in VVC) that corresponds to a quantization step size equal to (or closest to) 1 in a video codec.

It is noted that these QP values (i.e., QP′y, QP′cb, QP′cr) are also applied to palette-coding CUs.

According to some techniques of this disclosure, QP clipping can be combined with the QGCU-level signaling as introduced above with respect to the enabling flag for ACT at QGCU level. The delta QP (i.e., the delta between original QP and the minimal allowed QP) range can be adjusted based on the value of Δy (as described above with respect to QP clipping for ACT). As the minimal value of base QP is M (e.g. 4), the minimal value of QPy can be derived as follows:

QPy_min+6*(internal bit depth−8)+Δy=M+6*(internal bit depth−input bit depth), and thus:

QPy_min=M−6*(input bit depth−8)−Δy.

Thus, the delta QP between the original QP (i.e., QPy) and the minimum allowed QP (i.e., QPy_min) can be derived.

ΔQP=QPy_min−Qpy=M−6*(internal bit depth−8)−Δy−QPy.

According to techniques of this disclosure, video encoder 200 and video decoder 300 may be configured to perform ACT for dual-tree block partitioning.

According to some techniques of this disclosure, ACT still can be applied when dual-tree block partitioning is used. When dual-tree block partitioning is enabled, color components C₁ and C₂ can be coded and reconstructed separately from C₀. Under the assumption that the color component of C₀ is coded and reconstructed earlier than the others of the same pixel, the forward color transform as described above can be re-formulated as:

$$[ \begin{matrix}{C}_{0}^{′} \\ {C}_{1}^{′} \\ {C}_{2}^{′}\end{matrix} ] = [ \begin{matrix}2 & 1 & 1 \\ 2 & - 1 & - 1 \\ 0 & - 2 & 2\end{matrix} ] [ \begin{matrix}\overline{{C}_{0}} \\ {C}_{1} \\ {C}_{2}\end{matrix} ] / 4 ,$$

where C̅₀̅ is the reconstruction signal of C₀. The encoding loop only signals the quantized signal of C₀, C′₁ and C′₂.

In a backward color transform, as shown below, the decoding loop has the reconstructed values (i.e., C̅₀̅, C̅′̅₁̅ and C̅′̅₂̅), and thus the backward transform cannot be applied directly because only C̅₀̅, and not C′₀, is known after decoding.

$$[ \begin{matrix}\overline{{C}_{0}} \\ \overline{{C}_{1}} \\ \overline{{C}_{2}}\end{matrix} ] = [ \begin{matrix}1 & 1 & 0 \\ 1 & - 1 & - 1 \\ 1 & - 1 & 1\end{matrix} ] [ \begin{matrix}\overline{{C}_{0}^{′}} \\ \overline{{C}_{1}^{′}} \\ \overline{{C}_{2}^{′}}\end{matrix} ] .$$

This formula can be re-formulated by swapping C̅₀̅ and C̅′̅₀̅ respectively to either side of the equation, as follows:

$$[ \begin{matrix}\overline{{C}_{0}^{′}} \\ \overline{{C}_{1}} \\ \overline{{C}_{2}}\end{matrix} ] = [ \begin{matrix}1 & - 1 & 0 \\ 1 & - 2 & - 1 \\ 1 & - 2 & 1\end{matrix} ] [ \begin{matrix}\overline{{C}_{0}} \\ \overline{{C}_{1}^{′}} \\ \overline{{C}_{2}^{′}}\end{matrix} ] .$$

In some examples, C₀ (and C̅₀̅ and C̅′̅₀̅) may not be available to be jointly coded with C₁ and C₂. When such case happens, C̅₀̅ is assigned with 0 when performing color conversion for the other two color components. Thus, the forward and backward color transform can be re-formulated respectively as follows:

$$[ \begin{matrix}0 \\ {C}_{1}^{′} \\ {C}_{2}^{′}\end{matrix} ] = [ \begin{matrix}2 & 1 & 1 \\ 2 & - 1 & - 1 \\ 0 & - 2 & 2\end{matrix} ] [ \begin{matrix}0 \\ {C}_{1} \\ {C}_{2}\end{matrix} ] / 4 \qquad and [ \begin{matrix}0 \\ {\overline{C}}_{1} \\ {\overline{C}}_{2}\end{matrix} ] = [ \begin{matrix}1 & - 1 & 0 \\ 1 & - 2 & - 1 \\ 1 & - 2 & 1\end{matrix} ] [ \begin{matrix}0 \\ \overline{{C}_{1}^{′}} \\ \overline{{C}_{2}^{′}}\end{matrix} ] ,$$

or in a compact form, as follows:

$$[ \begin{matrix}{C}_{1}^{′} \\ {C}_{2}^{′}\end{matrix} ] = [ \begin{matrix}- 1 & - 1 \\ - 2 & 2\end{matrix} ] [ \begin{matrix}{C}_{1} \\ {C}_{2}\end{matrix} ] / 4 \qquad and [ \begin{matrix}\overline{{C}_{1}} \\ \overline{{C}_{2}}\end{matrix} ] = [ \begin{matrix}- 2 & - 1 \\ - 2 & 1\end{matrix} ] [ \frac{\overline{{C}_{1}^{′}}}{{C}_{2}^{′}} ] / 4.$$

It is noted that when pps_slice_act_qp_offset_spresent_flag is enabled, every CU can have an enable flag for ACT. In addition, the italicized branch condition as described in the syntax table above with respect to the signaling of QP offsets can be redefined as follows.

if(pps_slice_act_qp_offsets_present_flag) {

if(slice_{—}type != I || !qtbtt_{—}dual_{—}tree_{—}intra_{—}flag )

| | |
|---|---|
| slice_ act _y_qp_offset | se(v) |

| | |
|---|---|
| slice_ act _cb_qp_offset | se(v) |
| slice_ act _cr_qp_offset | se(v) |

| | |
|---|---|
| } | se(v) |

Also, according to some techniques of this disclosure, the QP offset of each color component for ACT can be signaled jointly for Y and Cb at slice header as follows:
joint QP offset for Y and Cb components:

if(pps_slice_act_qp_offsets_present_flag){

| | |
|---|---|
| slice_ act _y_cb_qp_offset | se(v) |
| slice_ act _cr_qp_offset | se(v) |

| | |
|---|---|
| } | se(v) |

joint QP offset for Y and Cr components:

if(pps_slice_act_qp_offsets_present){

| | |
|---|---|
| slice_ act _y_cr_qp_offset | se(v) |
| slice_ act _cb_qp_offset | se(v) |

| | |
|---|---|
| } | se(v) |

joint QP offset for Cb and Cr components:

if(pps_slice_act_qp_offsets_present_flag){

if(slice_{—}type != I || !qtbtt_{—}dual_{—}tree_{—}intra_{—}flag )

| | |
|---|---|
| slice_ act _y_qp_offset | se(v) |

| | |
|---|---|
| slice_ act _cb_cr_qp_offset | se(v) |

| | |
|---|---|
| } | se(v) |

joint QP offset for all color components:

if(pps_slice_act_qp_offsets_present_flag) {

| | |
|---|---|
| slice_ act _qp_offset | se(v) |

| | |
|---|---|
| } | se(v) |

According to techniques of this disclosure, video encoder 200 and video decoder 300 may be configured to utilize separate QP offsets for JointCbCr mode. That is, video encoder 200 and video decoder 300 may be configured to determine an ACT QP offset for the block based on the block being encoded using the ACT and encoded in the joint chroma mode (e.g., JointCbCr mode). Video encoder 200 and video decoder 300 may, for example, store a set of ACT QP offsets, with the set including a first ACT QP offset for luma residual components of the video data, a second ACT QP offset for first chroma residual components of the video data, a third ACT QP offset for second chroma residual components of the video data, and a fourth ACT QP offset for jointly coded chroma residual components. The fourth ACT QP offset may be different than one or both of the second and third ACT QP offsets.

VVC Draft 7 includes a JointCbCr mode where only one block of chroma residual is coded, denoted as a CbCr residual. At video decoder 300, after the CbCr residual is reconstructed, the Cb and Cr residual are derived depending on the selected JointCbCr modes. In one of JointCbCr modes, denoted as mode 2 in VVC, the Cr residual is set to be the same as the CbCr residual, and the Cb residual is set as Cb=Csign*Cr, where Csign may be 1 or −1 depending on the JointCbCr mode. If JointCbCr mode 2 is used for a coding unit, a separate QP offset that is designated for the CbCr residual may be applied.

According to techniques of this disclosure, video encoder 200 and video decoder 300 may be configured to use a separate ACT QP offset if JointCbCr mode 2 is applied to an ACT block for residual coding. Therefore, overall, there may be four ACT QP offsets, one for luma, one for Cb, one for Cr, and one for CbCr.

In some examples, the separate ACT QP offset for JointCbCr mode 2 may be fixed to an integer value. In some examples, the separate ACT QP offset for JointCbCr mode may be signaled as for the other ACT QP offsets. For example, a pps_act_cb_cr_qp_offset_plus5 may be signaled in picture parameter set as for pps_act_cb_qp_offset_plus5, and a slice_act_cb_cr_qp_offset may be signaled in slice header as for slice_act_cr_qp_offset.

In some examples, the separate ACT QP offset (pps_act_cb_cr_qp_offset_plus5 and slice_act_cb_cr_qp_offset) for JointCbCr mode may be signaled only if JointCbCr mode is enabled at SPS.

In some examples, the separate ACT QP offset for JointCbCr mode may be always signaled even JointCbCr mode is not enabled at SPS.

To implement the various techniques described above, video encoder 200 may be configured to determine a first chroma residual block for a first chroma component of a block of video data; determine a second chroma residual block for a second chroma component of the block of video data, wherein the first chroma residual block and the second chroma residual block are in a first color space; determine that the block of the video data is encoded using an adaptive color transform (ACT); perform the ACT on the first chroma residual block to convert the first chroma residual block to a second color space; perform the inverse ACT on the second chroma residual block to convert the second chroma residual block to the second color space; determine that the block of the video data is encoded in a joint chroma mode, wherein for the joint chroma mode a single chroma residual block is encoded for the first chroma component of the block and the second chroma component of the block; determine the single chroma residual block based on the converted first chroma residual block and the converted second chroma residual block; determine a QP for the block; determine an ACT QP offset for the block based on the block being encoded using the ACT and encoded in the joint chroma mode; determine an ACT QP for the block based on the QP and the ACT QP offset; and quantize the single chroma residual block based on the ACT QP for the block.

To implement the various techniques described above, video decoder 300 may be configured to determine that a block of the video data is encoded using an ACT; determine that the block is encoded in a joint chroma mode, wherein for the joint chroma mode a single chroma residual block is encoded for a first chroma component of the block and a second chroma component of the block; determine a QP for the block; determine an ACT QP offset for the block based on the block being encoded using the ACT and encoded in the joint chroma mode; determine an ACT QP for the block based on the QP and the ACT QP offset; determine the single chroma residual block based on the ACT QP for the block; determine a first chroma residual block for the first chroma component from the single chroma residual block, wherein the first chroma residual block is in a first color space; determine a second chroma residual block for the second chroma component from the single chroma residual block, wherein the second chroma residual block is in the first color space; perform an inverse ACT on the first chroma residual block to convert the first chroma residual block to a second color space; and perform the inverse ACT on the second chroma residual block to convert the second chroma residual block to the second color space.

FIG. 3 is a block diagram illustrating an example video encoder 200 that may perform the techniques of this disclosure. FIG. 3 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266 video coding standard in development. However, the techniques of this disclosure are not limited to these video coding standards and are applicable generally to video encoding and decoding.

In the example of FIG. 3, video encoder 200 includes video data memory 230, mode selection unit 202, residual generation unit 204, ACT unit 205, transform processing unit 206, quantization unit 208, inverse quantization unit 210, inverse transform processing unit 212, inverse ACT unit 213, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, of FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 3 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples where video data is coded in a joint chroma mode, residual generation unit 204 may determine a single chroma residual block from two separate chroma residual blocks. In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block. In scenarios where ACT is enabled, ACT unit 205 may perform an ACT on a residual block to convert the residual block from a first color space to a second color space. In scenarios where ACT is not enabled, ACT unit 205 may act as a pass through unit that does not alter the residual block output by residual generation unit 204.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a QP value associated with the current block. Video encoder 200 (e.g., via mode selection unit 202) may adjust the degree of quantization applied to the transform coefficient blocks associated with the current block by adjusting the QP value associated with the CU.

For a block of video data that is encoded in a joint chroma mode and using ACT, quantization unit 208 may determine an ACT QP offset for the block based on the block being encoded using the ACT and encoded in the joint chroma mode and determine an ACT QP for the block based on the QP value and the ACT QP offset. Thus, for a block of video data that is encoded in a joint chroma mode and using ACT, quantization unit 208 may quantize the block using the ACT QP value rather than the QP value. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. For a block of video data that is encoded in a joint chroma mode and using ACT, inverse quantization unit 210 may determine an ACT QP offset for the block based on the block being encoded using the ACT and encoded in the joint chroma mode and determine an ACT QP for the block based on the QP value and the ACT QP offset. Thus, for a block of video data that is encoded in a joint chroma mode and using ACT, inverse quantization unit 210 may dequantize the block using the ACT QP value rather than the QP value.

In scenarios where ACT is enabled, inverse ACT unit 213 may perform an inverse ACT on the reconstructed residual block to convert the residual block from a second color space back to a first color space. In scenarios where ACT is not enabled, inverse ACT unit 213 may act as a pass through unit that does not alter the reconstructed residual block output by inverse transform processing unit 212.

Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to determine that one or more QP offset values are included in a slice header; in response to determining that the one or more QP offset values are included in the slice header, generating a flag with a first value for inclusion in a parameter set, wherein the first value for the flag indicates that the one or more QP offset values are included in the slice header and a second value for the flag indicates that the one or more QP offset values are not included in the slice header; in response to determining that the one or more QP offset values are included in the slice header, generate for inclusion in the slice header, the one or more QP offset values; perform adaptive color transform on residual data based on the one or more QP offset values to determine color transformed residual data. Video encoder 200 may additionally or alternatively be configured to determine whether adaptive color transform is enabled or disabled for a quantization group of a coding unit (QGCU); in response to determining that adaptive color transform is enabled for the QGCU, generate for inclusion in the video data, a flag indicating that adaptive color transform is enabled or disabled for the QGCU; and process sample values of the QGCU in a color-transform domain.

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, this disclosure describes video decoder 300 according to the techniques of JEM, VVC, and HEVC. However, the techniques of this disclosure may be performed by video coding devices that are configured to other video coding standards.

In the example of FIG. 4, video decoder 300 includes coded picture buffer (CPB) memory 320, entropy decoding unit 302, prediction processing unit 304, inverse quantization unit 306, inverse transform processing unit 308, inverse ACT unit 309, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, of FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 4 are illustrated to assist with understanding the operations performed by video decoder 300. The units may be implemented as fixed-function circuits, programmable circuits, or a combination thereof. Similar to FIG. 3, fixed-function circuits refer to circuits that provide particular functionality, and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a QP and/or transform mode indication(s). Inverse quantization unit 306 may use the QP associated with the quantized transform coefficient block to determine a degree of quantization and, likewise, a degree of inverse quantization for inverse quantization unit 306 to apply. For a block of video data that is encoded in a joint chroma mode and using ACT, inverse quantization unit 306 may determine an ACT QP offset for the block based on the block being encoded using the ACT and encoded in the joint chroma mode and determine an ACT QP for the block based on the QP value and the ACT QP offset. Thus, for a block of video data that is encoded in a joint chroma mode and using ACT, inverse quantization unit 306 may dequantize the block using the ACT QP value rather than the QP value. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

In scenarios where ACT is enabled, inverse ACT unit 309 may perform an inverse ACT on the residual block to convert the residual block from a second color space back to a first color space. In scenarios where ACT is not enabled, inverse ACT unit 309 may act as a pass through unit that does not alter the residual block output by inverse transform processing unit 308.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 3).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 3). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to receive a flag in a parameter set, wherein a first value for the flag indicates that one or more QP offset values are included in a slice header and a second value for the flag indicates that the one or more QP offset values are not included in the slice header; in response to determining that the flag has the first value, receive in the slice header the one or more QP offset values; perform adaptive color transform on residual data based on the one or more QP offset values. Video decoder 300 may additionally or alternatively be configured to receive a flag, at a quantization group of a coding unit (QGCU) level, indicating whether adaptive color transform is enabled or disabled for the QGCU; and in response to determining that the flag indicates adaptive color transform is enabled for the QGCU, process sample values of the QGCU in a color-transform domain.

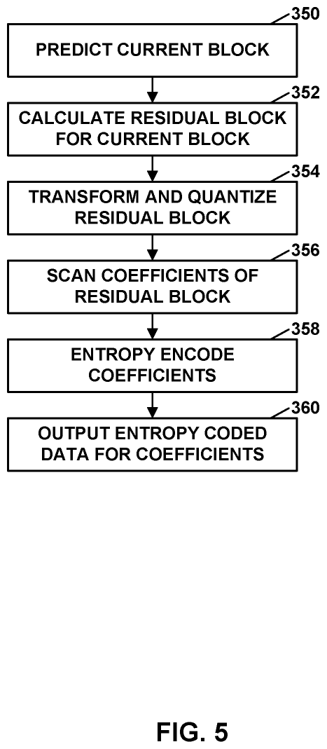

FIG. 5 is a flowchart illustrating an example method for encoding a current block. The current block may comprise a current CU. Although described with respect to video encoder 200 (FIGS. 1 and 3), it should be understood that other devices may be configured to perform a method similar to that of FIG. 5.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. For some blocks, video encoder 200 may also calculate the residual block by performing ACT as described above. Video encoder 200 may then transform and quantize coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

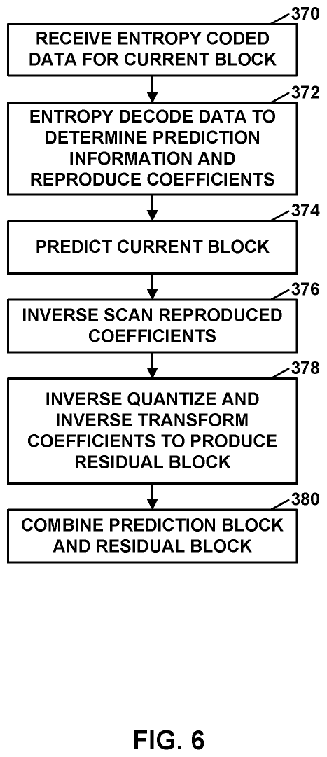

FIG. 6 is a flowchart illustrating an example method for decoding a current block of video data. The current block may comprise a current CU. Although described with respect to video decoder 300 (FIGS. 1 and 4), it should be understood that other devices may be configured to perform a method similar to that of FIG. 6.

Video decoder 300 may receive entropy encoded data for the current block, such as entropy encoded prediction information and entropy encoded data for coefficients of a residual block corresponding to the current block (370). Video decoder 300 may entropy decode the entropy encoded data to determine prediction information for the current block and to reproduce coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced coefficients (376), to create a block of quantized transform coefficients. Video decoder 300 may then inverse quantize and inverse transform the transform coefficients to produce a residual block (378). For some blocks, video decoder may also perform ACT as described above to produce the residual block. Video decoder 300 may ultimately decode the current block by combining the prediction block and the residual block (380).

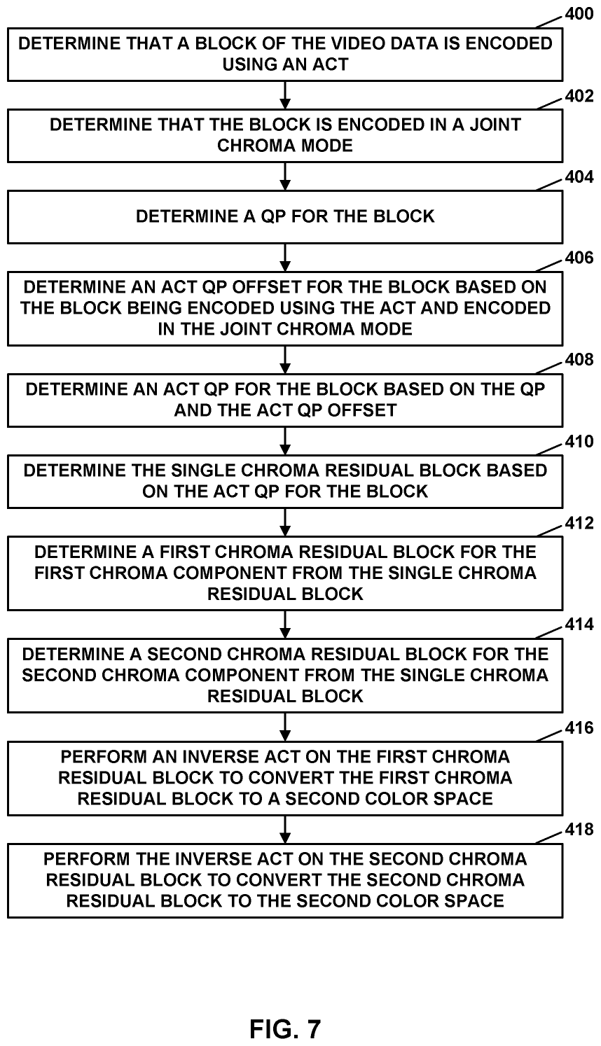

FIG. 7 is a flowchart illustrating an example method for decoding a current block of video data. The current block may comprise a current CU. Although described with respect to video decoder 300 (FIGS. 1 and 4), it should be understood that other devices may be configured to perform a method similar to that of FIG. 7.

Video decoder 300 determines that a block of the video data is encoded using an ACT (400). Video decoder 300 may, for example, determine that the block of the video data is encoded using the ACT by receiving a CU level flag indicating that the ACT is enabled for the block.

Video decoder 300 determines that the block is encoded in a joint chroma mode (402). As described above, for the joint chroma mode, a single chroma residual block may be encoded for a first chroma component of the block and a second chroma component of the block. Video decoder 300 may determine that the block is encoded in the joint chroma mode by, for example, receiving a CU level syntax element indicating that a joint chroma mode is enabled for the block.

Video decoder 300 determines a QP for the block (404). Video decoder 300 may, for example, determine the QP for the block at a quantization group level. A quantization group may be the same size as or larger or smaller than the block, such that the QP for the block may be one of multiple QPs for the block or apply to multiple blocks.

Video decoder 300 determines an ACT QP offset for the block based on the block being encoded using the ACT and encoded in the joint chroma mode (406). Video decoder 300 may, for example, store a set of ACT QP offsets, with the set including a first ACT QP offset for luma residual components of the video data, a second ACT QP offset for first chroma residual components of the video data, a third ACT QP offset for second chroma residual components of the video data, and a fourth ACT QP offset for jointly coded chroma residual components. To determine the ACT QP offset for the block based on the block being encoded using the ACT and encoded in the joint chroma mode, video decoder 300 may be configured to set a value for the ACT QP offset to a value for the fourth ACT QP offset in response to the block being encoded using the ACT and encoded in the joint chroma mode. To determine the ACT QP offset for the block based on the block being encoded using the ACT and encoded in the joint chroma mode, video decoder 300 may be configured to set the ACT QP offset to a fixed, integer value. In this context, fixed may, for example, mean that the ACT QP offset is defined in a CODEC being executed by video decoder 300.

Video decoder 300 determines an ACT QP for the block based on the QP and the ACT QP offset (408). Video decoder 300 determines the single chroma residual block based on the ACT QP for the block (410). That is, video decoder 300 may dequantize a block of quantized transform coefficients to determine the single chroma residual block.

Video decoder 300 determines a first chroma residual block for the first chroma component from the single chroma residual block (412). Video decoder 300 determines a second chroma residual block for the second chroma component from the single chroma residual block (414). The first and second and second chroma residual blocks may be in a first color space, such as a YCgCo color space.

To determine the first chroma residual block for the first chroma component from the single chroma residual block, video decoder 300 may, for example, set sample values for the first chroma residual block equal to values of corresponding samples in the single chroma residual block. To determine the second chroma residual block for the second chroma component from the single chroma residual block, video decoder 300 may set sample values for the second chroma residual block equal to values of corresponding samples in the first chroma residual block multiplied by negative one.

Video decoder 300 performs an inverse ACT on the first chroma residual block to convert the first chroma residual block to a second color space (416). Video decoder 300 performs the inverse ACT on the second chroma residual block to convert the second chroma residual block to the second color space (418). Video decoder 300 may add the converted first chroma residual block to a first predicted chroma block to determine a first reconstructed chroma block; add the converted second chroma residual block to a second predicted chroma block to determine a second reconstructed chroma block; and output the first reconstructed chroma block and the second reconstructed chroma block.

Video decoder 300 may also determine that a second block of the video data is encoded using the ACT; determine that the second block is not encoded in the joint chroma mode; determine a QP for the second block; determine a second ACT QP offset for a first chroma component of the second block based on the second block being encoded using the ACT and not encoded in the joint chroma mode; and determine a third ACT QP offset for a second chroma component of the second block based on the second block being encoded using the ACT and not encoded in the joint chroma mode, wherein at least one of the second ACT QP offset and the third ACT QP offset is different than the first ACT QP offset.

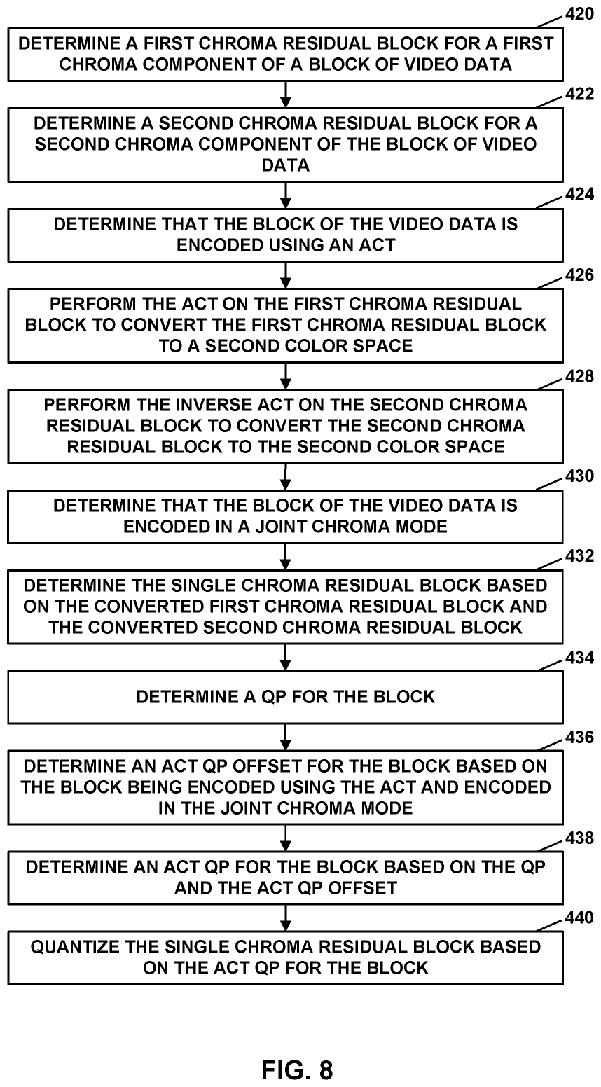

FIG. 8 is a flowchart illustrating an example method for encoding a current block. The current block may comprise a current CU. Although described with respect to video encoder 200 (FIGS. 1 and 3), it should be understood that other devices may be configured to perform a method similar to that of FIG. 8.

Video encoder 200 determines a first chroma residual block for a first chroma component of a block of video data (420). Video encoder 200 determines a second chroma residual block for a second chroma component of the block of video data, wherein the first chroma residual block and the second chroma residual block are in a first color space (422). Video encoder 200 determines that the block of the video data is encoded using an ACT (424). Video encoder 200 performs the ACT on the first chroma residual block to convert the first chroma residual block to a second color space (426). Video encoder 200 performs the inverse ACT on the second chroma residual block to convert the second chroma residual block to the second color space (428). The second color space may, for example, be a YCgCo color space. Video encoder 200 determines that the block of the video data is encoded in a joint chroma mode (430). In the joint chroma mode, video encoder 200 encodes a single chroma residual block for the first chroma component of the block and the second chroma component of the block. Video encoder 200 determines the single chroma residual block based on the converted first chroma residual block and the converted second chroma residual block (432). Video encoder 200 determines a QP for the block (434).

Video encoder 200 determines an ACT QP offset for the block based on the block being encoded using the ACT and encoded in the joint chroma mode (436). Video encoder 200 may store a set of ACT QP offsets with the set of ACT QP offsets including a first ACT QP offset for luma residual components of the video data, a second ACT QP offset for first chroma residual components of the video data, a third ACT QP offset for second chroma residual components of the video data, and a fourth ACT QP offset for jointly coded chroma residual components. To determine the ACT QP offset for the block based on the block being encoded using the ACT and encoded in the joint chroma mode, video encoder 200 may set a value for the ACT QP offset to a value for the fourth ACT QP offset in response to the block being encoded using the ACT and encoded in the joint chroma mode. The method of claim 12, wherein To determine the ACT QP offset for the block based on the block being encoded using the ACT and encoded in the joint chroma mode, video encoder 200 may set the ACT QP offset to a fixed, integer value.

Video encoder 200 determines an ACT QP for the block based on the QP and the ACT QP offset (438). Video encoder 200 quantizes the single chroma residual block based on the ACT QP for the block (440). Video encoder 200 may then transform the quantized single chroma residual block to generate transform coefficients and output syntax elements to identifying the transform coefficients.

The following clauses describe example devices and processes in accordance with video encoder 200 and video decoder 300 and the techniques discussed above.

Clause 1: A method of decoding video data includes receiving a flag in a parameter set, wherein a first value for the flag indicates that one or more quantization parameter (QP) offset values are included in a slice header and a second value for the flag indicates that the one or more QP offset values are not included in the slice header; in response to determining that the flag has the first value, receiving in the slice header the one or more QP offset values; and performing adaptive color transform on residual data based on the one or more QP offset values.

Clause 2: The method of clause 1, further includes receiving the flag in a parameter set in response to determining that adaptive color transform is enabled.

Clause 3: The method of clause 1 or 2, further includes receiving, in the slice header, the one or more QP offset values further in response to determining that a slice type for the slice of the slice header is not an I slice.

Clause 4: The method of clause 1 or 2, further includes receiving, in the slice header, the one or more QP offset values further in response to determining that the slice of the slice header does not use dual-tree block partitioning.

Clause 5: The method of any of clauses 1-4, wherein the parameter set is a picture parameter set.

Clause 6: The method of any of clauses 1-5, further includes determining values for quantized transform coefficients; inverse quantizing the values for the quantized transform coefficients to determines values for dequantized transform coefficients; inverse transforming the dequantized transform coefficients to determine the residual data.

Clause 7: The method of any of clauses 1-5, wherein the residual data comprises transform-skipped residual data.

Clause 8: A method of decoding video data includes receiving a flag, at a quantization group of a coding unit (QGCU) level, indicating whether adaptive color transform is enabled or disabled for the QGCU; and in response to determining that the flag indicates adaptive color transform is enabled for the QGCU, processing sample values of the QGCU in a color-transform domain.

Clause 9: A method of decoding video data includes determining that a residual block of video data is coded in a JointCbCr mode; receiving a JointCbCr offset value; performing adaptive color transform on the residual data based on the JointCbCr offset value.

Clause 10: The method of clause 8, further comprising any one of or combination of clauses 1-8.

Clause 11: A device for coding video data, the device comprising one or more means for performing the method of any of clauses 1-10.

Clause 12: The device of clause 11, wherein the one or more means comprise one or more processors implemented in circuitry.

Clause 13: The device of any of clauses 11 and 12, further comprising a memory to store the video data.

Clause 14: The device of any of clauses 11-13, further comprising a display configured to display decoded video data.

Clause 15: The device of any of clauses 11-14, wherein the device comprises one or more of a camera, a computer, a mobile device, a broadcast receiver device, or a set-top box.

Clause 16: The device of any of clauses 6-15, wherein the device comprises a video decoder.

Clause 17: A method of encoding video data includes determining that one or more quantization parameter (QP) offset values are included in a slice header; in response to determining that the one or more QP offset values are included in the slice header, generating a flag with a first value for inclusion in a parameter set, wherein the first value for the flag indicates that the one or more QP offset values are included in the slice header and a second value for the flag indicates that the one or more QP offset values are not included in the slice header; in response to determining that the one or more QP offset values are included in the slice header, generating for inclusion in the slice header, the one or more QP offset values; performing adaptive color transform on residual data based on the one or more QP offset values to determine color transformed residual data.

Clause 18: The method of clause 17, further includes generating the flag for inclusion in the parameter set in response to determining that adaptive color transform is enabled.

Clause 19: The method of clause 17 or 18, further includes generating, for inclusion in the slice header, the one or more QP offset values further in response to determining that a slice type for the slice of the slice header is not an I slice.

Clause 20: The method of clause 17 or 18, further includes generating, for inclusion in the slice header, the one or more QP offset values further in response to determining that the slice of the slice header does not use dual-tree block partitioning.

Clause 21: The method of any of clauses 17-20, wherein the parameter set is a picture parameter set.

Clause 22: The method of any of clauses 17-21, further includes transforming color transformed residual data to determine transform coefficients; quantizing the transform coefficients; and signaling, in the video data, the quantized transform coefficients.

Clause 23: The method of any of clauses 17-22, further includes signaling in the video data, the color transformed residual data.

Clause 24: A method of encoding video data includes determining whether adaptive color transform is enabled or disabled for a quantization group of a coding unit (QGCU); in response to determining that adaptive color transform is enabled for the QGCU, generating for inclusion in the video data, a flag indicating that adaptive color transform is enabled or disabled for the QGCU; and processing sample values of the QGCU in a color-transform domain.

Clause 25: The method of clause 24, further comprising any one of or combination of clauses 16-22.

Clause 26: A device for encoding video data, the device comprising one or more means for performing the method of any of clauses 17-25.

Clause 27: The device of clause 26, wherein the one or more means comprise one or more processors implemented in circuitry.

Clause 28: The device of any of clauses 26 and 27, further comprising a memory to store the video data.

Clause 29: The device of any of clauses 26-28, wherein the device comprises one or more of a camera, a computer, a mobile device, a broadcast receiver device, or a set-top box.

Clause 30: The device of any of clauses 26-29, wherein the device comprises a video encoder.

Clause 31: A computer-readable storage medium having stored thereon instructions that, when executed, cause one or more processors to perform the method of any of clauses 1-10 or 17-25.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining that a block of the video data is encoded using an adaptive color transform (ACT);
determining that the block is encoded in a joint chroma mode, wherein for the joint chroma mode a single chroma residual block is encoded for a first chroma component of the block and a second chroma component of the block;
determining a quantization parameter (QP) for the block;
determining an ACT quantization parameter (QP) offset for the block based on the block being encoded using the ACT and encoded in the joint chroma mode;
determining an ACT QP for the block based on the QP and the ACT QP offset;
determining the single chroma residual block based on the ACT QP for the block;
determining a first chroma residual block for the first chroma component from the single chroma residual block, wherein the first chroma residual block is in a first color space;
determining a second chroma residual block for the second chroma component from the single chroma residual block, wherein the second chroma residual block is in the first color space;
performing an inverse ACT on the first chroma residual block to convert the first chroma residual block to a second color space; and
performing the inverse ACT on the second chroma residual block to convert the second chroma residual block to the second color space.

2. The method of claim 1, wherein determining the ACT QP offset for the block based on the block being encoded using the ACT and encoded in the joint chroma mode comprises setting the ACT QP offset to a fixed, integer value.

3. The method of claim 1, further comprising:
storing a set of ACT QP offsets, wherein the set of ACT QP offsets comprises a first ACT QP offset for luma residual components of the video data, a second ACT QP offset for first chroma residual components of the video data, a third ACT QP offset for second chroma residual components of the video data, and a fourth ACT QP offset for jointly coded chroma residual components.

4. The method of claim 3, wherein determining the ACT QP offset for the block based on the block being encoded using the ACT and encoded in the joint chroma mode comprises setting a value for the ACT QP offset to a value for the fourth ACT QP offset in response to the block being encoded using the ACT and encoded in the joint chroma mode.

5. The method of claim 1, wherein the first color space comprises a YCgCo color space.

6. The method of claim 1, further comprising:
adding the converted first chroma residual block to a first predicted chroma block to determine a first reconstructed chroma block;
adding the converted second chroma residual block to a second predicted chroma block to determine a second reconstructed chroma block; and
outputting the first reconstructed chroma block and the second reconstructed chroma block.

7. The method of claim 1, further comprising:
determining that a second block of the video data is encoded using the ACT;
determining that the second block is not encoded in the joint chroma mode;
determining a QP for the second block;
determining a second ACT QP offset for a first chroma component of the second block based on the second block being encoded using the ACT and not encoded in the joint chroma mode;
determining a third ACT QP offset for a second chroma component of the second block based on the second block being encoded using the ACT and not encoded in the joint chroma mode, wherein at least one of the second ACT QP offset and the third ACT QP offset is different than the first ACT QP offset.

8. The method of claim 1, wherein determining the first chroma residual block for the first chroma component from the single chroma residual block comprises setting sample values for the first chroma residual block equal to values of corresponding samples in the single chroma residual block.

9. The method of claim 8, wherein determining the second chroma residual block for the second chroma component from the single chroma residual block comprises setting sample values for the second chroma residual block equal to values of corresponding samples in the first chroma residual block.

10. The method of claim 8, wherein determining the second chroma residual block for the second chroma component from the single chroma residual block comprises setting sample values for the second chroma residual block equal to values of corresponding samples in the first chroma residual block multiplied by negative one.

11. The method of claim 1, wherein determining the single chroma residual block based on the ACT QP for the block comprises:
receiving a set of transform coefficients;
performing an inverse quantization operation on the set of transform coefficients to determine a set of dequantized transform coefficients, wherein an amount of dequantization for the inverse quantization operation is controlled by the ACT QP; and
inverse transforming the set of dequantized transform coefficients to determine the single chroma residual block.

12. A method of encoding video data, the method comprising:
determining a first chroma residual block for a first chroma component of a block of video data;
determining a second chroma residual block for a second chroma component of the block of video data, wherein the first chroma residual block and the second chroma residual block are in a first color space;
determining that the block of the video data is encoded using an adaptive color transform (ACT);
performing the ACT on the first chroma residual block to convert the first chroma residual block to a second color space;
performing the inverse ACT on the second chroma residual block to convert the second chroma residual block to the second color space;
determining that the block of the video data is encoded in a joint chroma mode, wherein for the joint chroma mode a single chroma residual block is encoded for the first chroma component of the block and the second chroma component of the block;
determining the single chroma residual block based on the converted first chroma residual block and the converted second chroma residual block;
determining a quantization parameter (QP) for the block;
determining an ACT quantization parameter (QP) offset for the block based on the block being encoded using the ACT and encoded in the joint chroma mode;
determining an ACT QP for the block based on the QP and the ACT QP offset; and
quantizing the single chroma residual block based on the ACT QP for the block.

13. The method of claim 12, wherein determining the ACT QP offset for the block based on the block being encoded using the ACT and encoded in the joint chroma mode comprises setting the ACT QP offset to a fixed, integer value.

14. The method of claim 12, further comprising:
storing a set of ACT QP offsets, wherein the set of ACT QP offsets comprises a first ACT QP offset for luma residual components of the video data, a second ACT QP offset for first chroma residual components of the video data, a third ACT QP offset for second chroma residual components of the video data, and a fourth ACT QP offset for jointly coded chroma residual components.

15. The method of claim 14, wherein determining the ACT QP offset for the block based on the block being encoded using the ACT and encoded in the joint chroma mode comprises setting a value for the ACT QP offset to a value for the fourth ACT QP offset in response to the block being encoded using the ACT and encoded in the joint chroma mode.

16. The method of claim 12, wherein the second color space comprises a YCgCo color space.

17. A device for decoding video data, the device comprising:
a memory configured to store video data;
one or more processors implemented in circuitry and configured to:
determine that a block of the video data is encoded using an adaptive color transform (ACT);
determine that the block is encoded in a joint chroma mode, wherein for the joint chroma mode a single chroma residual block is encoded for a first chroma component of the block and a second chroma component of the block;
determine a quantization parameter (QP) for the block;
determine an ACT quantization parameter (QP) offset for the block based on the block being encoded using the ACT and encoded in the joint chroma mode;
determine an ACT QP for the block based on the QP and the ACT QP offset;
determine the single chroma residual block based on the ACT QP for the block;
determine a first chroma residual block for the first chroma component from the single chroma residual block, wherein the first chroma residual block is in a first color space;
determine a second chroma residual block for the second chroma component from the single chroma residual block, wherein the second chroma residual block is in the first color space;
perform an inverse ACT on the first chroma residual block to convert the first chroma residual block to a second color space; and
perform the inverse ACT on the second chroma residual block to convert the second chroma residual block to the second color space.

18. The device of claim 17, wherein to determine the ACT QP offset for the block based on the block being encoded using the ACT and encoded in the joint chroma mode, the one or more processors are further configured to set the ACT QP offset to a fixed, integer value.

19. The device of claim 17, wherein the one or more processors are further configured to:
store a set of ACT QP offsets, wherein the set of ACT QP offsets comprises a first ACT QP offset for luma residual components of the video data, a second ACT QP offset for first chroma residual components of the video data, a third ACT QP offset for second chroma residual components of the video data, and a fourth ACT QP offset for jointly coded chroma residual components.

20. The device of claim 19, wherein to determine the ACT QP offset for the block based on the block being encoded using the ACT and encoded in the joint chroma mode, the one or more processors are further configured to set a value for the ACT QP offset to a value for the fourth ACT QP offset in response to the block being encoded using the ACT and encoded in the joint chroma mode.

21. The device of claim 17, wherein the first color space comprises a YCgCo color space.

22. The device of claim 17, wherein the one or more processors are further configured to:
add the converted first chroma residual block to a first predicted chroma block to determine a first reconstructed chroma block;
add the converted second chroma residual block to a second predicted chroma block to determine a second reconstructed chroma block; and
output the first reconstructed chroma block and the second reconstructed chroma block.

23. The device of claim 17, wherein the one or more processors are further configured to:
determine that a second block of the video data is encoded using the ACT;
determine that the second block is not encoded in the joint chroma mode;
determine a QP for the second block;
determine a second ACT QP offset for a first chroma component of the second block based on the second block being encoded using the ACT and not encoded in the joint chroma mode;
determine a third ACT QP offset for a second chroma component of the second block based on the second block being encoded using the ACT and not encoded in the joint chroma mode, wherein at least one of the second ACT QP offset and the third ACT QP offset is different than the first ACT QP offset.

24. The device of claim 17, wherein to determine the first chroma residual block for the first chroma component from the single chroma residual block, the one or more processors are further configured to set sample values for the first chroma residual block equal to values of corresponding samples in the single chroma residual block.

25. The device of claim 24, wherein to determine the second chroma residual block for the second chroma component from the single chroma residual block, the one or more processors are further configured to set sample values for the second chroma residual block equal to values of corresponding samples in the first chroma residual block.

26. The device of claim 24, wherein to determine the second chroma residual block for the second chroma component from the single chroma residual block, the one or more processors are further configured to set sample values for the second chroma residual block equal to values of corresponding samples in the first chroma residual block multiplied by negative one.

27. The device of claim 17, wherein to determine the single chroma residual block based on the ACT QP for the block, the one or more processors are further configured to:
receive a set of transform coefficients;
perform an inverse quantization operation on the set of transform coefficients to determine a set of dequantized transform coefficients, wherein an amount of dequantization for the inverse quantization operation is controlled by the ACT QP; and
inverse transform the set of dequantized transform coefficients to determine the single chroma residual block.

28. The device of claim 17, wherein the device comprises a wireless communication device, further comprising a receiver configured to receive encoded video data.

29. The device of claim 28, wherein the wireless communication device comprises a telephone handset and wherein the receiver is configured to demodulate, according to a wireless communication standard, a signal comprising the encoded video data.

30. The device of claim 17, further comprising:
a display configured to display decoded video data.

31. The device of claim 17, wherein the device comprises one or more of a camera, a computer, a mobile device, a broadcast receiver device, or a set-top box.

32. A device for encoding video data, the device comprising:
a memory configured to store video data;
one or more processors implemented in circuitry and configured to:
determine a first chroma residual block for a first chroma component of a block of video data;
determine a second chroma residual block for a second chroma component of the block of video data, wherein the first chroma residual block and the second chroma residual block are in a first color space;
determine that the block of the video data is encoded using an adaptive color transform (ACT);
perform the ACT on the first chroma residual block to convert the first chroma residual block to a second color space;
perform the inverse ACT on the second chroma residual block to convert the second chroma residual block to the second color space;
determine that the block of the video data is encoded in a joint chroma mode, wherein for the joint chroma mode a single chroma residual block is encoded for the first chroma component of the block and the second chroma component of the block;
determine the single chroma residual block based on the converted first chroma residual block and the converted second chroma residual block;
determine a quantization parameter (QP) for the block;
determine an ACT quantization parameter (QP) offset for the block based on the block being encoded using the ACT and encoded in the joint chroma mode;
determine an ACT QP for the block based on the QP and the ACT QP offset; and
quantize the single chroma residual block based on the ACT QP for the block.

33. The device of claim 32, wherein to determine the ACT QP offset for the block based on the block being encoded using the ACT and encoded in the joint chroma mode, the one or more processors are further configured to set the ACT QP offset to a fixed, integer value.

34. The device of claim 32, wherein the one or more processors are further configured to:
store a set of ACT QP offsets, wherein the set of ACT QP offsets comprises a first ACT QP offset for luma residual components of the video data, a second ACT QP offset for first chroma residual components of the video data, a third ACT QP offset for second chroma residual components of the video data, and a fourth ACT QP offset for jointly coded chroma residual components.

35. The device of claim 34, wherein to determine the ACT QP offset for the block based on the block being encoded using the ACT and encoded in the joint chroma mode, the one or more processors are further configured to set a value for the ACT QP offset to a value for the fourth ACT QP offset in response to the block being encoded using the ACT and encoded in the joint chroma mode.

36. The device of claim 32, wherein the second color space comprises a YCgCo color space.

37. The device of claim 32, wherein the device comprises a camera configured to capture the video data.
